(19) United States
(12) Patent Application Publication
(10) Pub. No.: US 2026/0360071 A1
(43) Pub. Date: Nov. 12, 2026

(54) LIDAR SUPERVISED SCENE RECONSTRUCTION

(71) Applicant: Ford Global Technologies, LLC, Dearborn, MI (US)

(72) Inventors: Pou-Chun Kung, Ann Arbor, MI (US); Xianling Zhang, San Mateo, CA (US); Nikita Jaipuria, Pittsburgh, PA (US)

(73) Assignee: Ford Global Technologies, LLC, Dearborn, MI (US)

(21) Appl. No.: 19/200,745

(22) Filed: May 7, 2025

(51) Int. Cl. G06T 15/08; G06T 13/20; G06T 15/20; G06V 10/774; G06V 20/56

(52) U.S. Cl. CPC G06T 15/08; G06T 13/20; G06T 15/20; G06V 10/774; G06V 20/56

(57) ABSTRACT

A computer that includes a processor and a memory, the memory including instructions executable by the processor to render a reconstructed video image based on three-dimensional (3D) Gaussian splatting by projecting 3D Gaussians from a selected point of view into a frame. A reconstructed lidar image can be rendered based on 3D Gaussian splatting by projecting the 3D Gaussians from the selected point of view into the frame including applying two-dimensional (2D) Gaussian scale compensation to the 3D Gaussians and a depth uncertainty filter to the 3D Gaussians. Training the rendering of the reconstructed video image and the reconstructed lidar image can be supervised by determining a loss function based combining the reconstructed lidar image with the reconstructed video image.

### BACKGROUND

Computers can operate systems and/or devices including vehicles, robots, drones, and/or object tracking systems. Data including images can be acquired by sensors and processed using a computer to determine locations of objects in an environment around the system. A computer may use the location data to determine trajectories for operating a system in the environment. The computer can then determine control data to transmit to system components to control system components to move the system according to the determined trajectories.

### BRIEF DESCRIPTION OF THE DRAWINGS

FIG. 1 is a block diagram of an example vehicle system.

FIG. 2 is a diagram of an example vehicle acquiring video images of a scene.

FIG. 3 is a diagram of an example vehicle acquiring lidar images of a scene.

FIG. 4 is a diagram of example moving object alignment.

FIG. 5 is a diagram of an example rendered video image.

FIG. 6 is a diagram of an example rendered lidar image.

FIG. 7 is a diagram of example depth uncertainty rendering.

FIG. 8 is a diagram of example lidar images illustrating depth uncertainty rendering.

FIG. 9 is a diagram of an example dynamic lidar supervised scene reconstruction system.

FIG. 10 is a flowchart diagram of an example process for dynamic lidar supervised scene reconstruction and training a neural network based on the reconstructed lidar and video images.

### DETAILED DESCRIPTION

Systems including vehicles, robots, drones, etc., can be operated by acquiring sensor data regarding an environment around the system and processing the sensor data to determine a location of the system in real world coordinates. The determined real world location data can be processed to determine a path upon which to operate the system or portions of the system. For example, a robot can determine the location of a gripper attached to a robotic arm with respect to a conveyer belt. The determined location can be used by the robot to determine a path upon which to operate to move portions of the robot to grasp the workpiece. A vehicle can determine locations of objects such as roadways and other vehicles. The vehicle can use the determined locations to operate the vehicle from a current location to a planned location while maintaining a predetermined distance from the edges of the roadway and other vehicles. Vehicle operation will be used as a non-limiting example of system location determination herein.

Machine learning models can be used to determine real world location data for vehicle operation based on vehicle sensors. Vehicle sensors can include video cameras and lidar sensors. Video sensors can acquire high spatial resolution color images but do not directly detect range or distance. Lidar sensors can use emitted laser radiation to determine distances from the sensor to locations in the scene. Lidar sensors can have sparse spatial resolution compared to video cameras but can sense range directly. A machine learning model executing on a computing device included in a vehicle can acquire video images and lidar images from sensors included in the vehicle and determine locations of objects such as roadways and other vehicles to determine a vehicle path upon which to operate. The computer can operate the vehicle on a determined vehicle path by controlling vehicle components such as propulsion, steering, and brakes.

Preparing the machine learning model to operate the vehicle can require training the machine learning model using a training dataset. A training dataset can include examples of video images and lidar images along with ground truth data. Ground truth is data that describes labels and locations of objects included in the video and lidar images. Ground truth data permits the training of a machine learning model by permitting comparison of the results of processing video or lidar images with data included in the ground truth to determine the accuracy of the machine learning results. The difference between ground truth and results can be used to determine a loss function that can be fed back to the machine learning model to select weights that program the machine learning model that can improve the accuracy of results. This process can be repeated many thousands or millions of times using many thousands or millions of images to determine weights to be included in the trained machine learning model.

Large numbers of video and lidar images can enhance training of machine learning models. One technique for obtaining large numbers of video and lidar images is to operate a vehicle on public roadways to acquire the video and lidar images using vehicle sensors. This can require time and resources to acquire the video and lidar image data under conditions that will approximate the conditions under which the vehicle will be operated, including time of day and changing weather conditions. Once the video and lidar images are acquired, the images can be annotated to determine ground truth for machine learning model training by identifying and locating objects such as vehicles and roadways in the images. Annotation can be performed manually by users examining the video and lidar images on a workstation or can be performed by computer software. Computer software that can annotate images includes image processing software such as segmentation software or neural networks. Annotation can also be performed by a combination of computer software and manual processing. Disadvantages of this real-world technique for generating training datasets include that coverage of the scenes acquired can be limited to the images acquired by the vehicle acquiring the data and the large amount of time and resources required to annotate the training dataset.

Another technique for obtaining training datasets includes generating synthetic images with video game-type rendering software. Video game-type rendering software generates image data from descriptions of the scene including object locations, orientations, colors, lighting, and weather conditions, etc. and descriptions of the virtual sensors that will be simulated to render the images. An example of video game-type rendering software is Unreal Engine, available from Epic Games, Inc., at http://epicgames.com as of the filing date of this application. Video game-type rendering software is designed to generate images that appear to a user at though they were acquired from real world scenes with real world sensors. An advantage of video game-type rendering is that the ground truth required to train machine learning models is included in the descriptions that are used to generate the image data. A disadvantage is that video game-type rendering software typically does not generate image data that looks enough like real world data to be used to fully train machine learning models.

Techniques for extending an original video image dataset can rely on determining 3D global coordinates of acquired video image pixels. A technique for determining 3D global coordinates of video image pixels is shape from motion (SfM). SfM includes identifying pixel features in two or more video images that correspond to the same location in 3D space and determining locations of the optical center of the video sensor in 3D global coordinates at the time the video images were acquired. SfM techniques can be used to generate image data from novel points of view to extend an existing training dataset. Drawbacks of SfM include sparse coverage of range data leading to voids and accuracy problems and limited ability to extend datasets beyond close range data such as city streets.

Other techniques for extending video image datasets include neural radiance fields (NeRF) reconstruction. NeRF synthesizes novel images of a scene based on a sparse set of input images by training a neural network based on the sparse set of input images. NeRF reconstruction can overcome SfM issues with voids and accuracy but can require many times more computing resources than supervised 3D Gaussian splatting. NeRF required retraining a neural network for each new scene to be reconstructed which can require several hours of computing time while supervised 3D Gaussian splatting can be performed in a few minutes. Even when NeRF can be extended to include lidar guidance, however, even with the addition of lidar guidance NeRF can require several hours of computing time to train the neural network to generate extensions to a scene.

Techniques described herein enhance generation of datasets for training machine learning models by performing lidar guided scene reconstruction based on 3D Gaussian splatting. 3D Gaussians are tensors that represent video and lidar data using data regarding sensor pose, scale, opacity, spherical harmonic representations of color and range data, and Gaussian covariance matrices to determine where a color or distance occurs in a scene. 3D Gaussians can be determined by modeling video image data included in multiple video images of a scene and modeling lidar image data included in multiple lidar images of a scene. Gaussian splatting refers to forming an image by adding values representing colors or distances to pixels of an image within Gaussian distributions about a mean. Representing an acquired set of video images and lidar images of a scene as 3D Gaussians permits generation of complete video and lidar images from novel points of view within the scene with accuracy that exceeds video game-type rendering while using a small fraction of the computing resources required for NeRF reconstruction. Further, 3D Gaussian reconstruction of video images using lidar supervision can permit the reconstruction of images that exceed the range and accuracy of SfM reconstruction. For example, lidar supervised scene reconstruction can render novel views of highway scenes that require rendering images that include accurate features such as roadways and vehicle at distances greater than about 50 meters with higher accuracy than SfM techniques.

Disclosed herein is a method including rendering a reconstructed video image based on image three-dimensional (3D) Gaussian splatting by projecting 3D Gaussians from a selected point of view into a frame, rendering a reconstructed lidar image based on the 3D Gaussian splatting by projecting the 3D Gaussians from the selected point of view into the frame including applying two-dimensional (2D) Gaussian scale compensation to the 3D Gaussians and a depth uncertainty filter to the 3D Gaussians, and supervising training the rendering of the reconstructed video image and the reconstructed lidar image by determining a loss function based combining the reconstructed lidar image with the reconstructed video image. The 3D Gaussians can be determined by modeling lidar image data included in multiple lidar images of a scene. Modeling range data included in the multiple lidar images as 3D Gaussians can include transforming Cartesian coordinates to spherical harmonic coefficients and transforming Gaussian covariance to spherical harmonic coefficients. The 3D Gaussians can be determined by modeling video image data included in multiple video images of a scene. Modeling the video image data included in the multiple video images can include transforming Cartesian coordinates to spherical harmonic coefficients and transforming Gaussian covariance to spherical harmonic coefficients. The frame can be a 2D rectangular shape based on solid angle projection of a field of view of a video camera from the selected point of view.

2D Gaussian scale compensation can include re-scaling the 3D Gaussians by increasing covariance Eigenvalues according to distance from the selected point of view. The 3D Gaussians can include a mean in global coordinates, a rotation quaternion, a scaling vector, an opacity, spherical harmonic coefficients which model color surface appearances and a covariance matrix. 3D Gaussian splatting can include determining a location in reconstructed pixel space based on the mean, the rotation quaternion, and scaling vector, and values to be added to the reconstructed pixel space are based on the spherical harmonic coefficients and the covariance matrix. The video images and the lidar images can include moving objects. The moving objects can be detected in lidar images and modeled into moving object 3D Gaussians included in lidar moving object models that include time stamps indicating when the moving object 3D Gaussians included the lidar moving object models were acquired. Rendering the moving object 3D Gaussians into the reconstructed lidar image can include determining trajectories for the moving objects and determining differences in time stamps between the moving object 3D Gaussians and the reconstructed video image. The depth uncertainty filter can remove depth uncertainty caused by projecting one or more of the 3D Gaussians onto a portion of the reconstructed lidar image based on uncertainty estimation. A machine learning model can be trained to operate a vehicle based on the reconstructed video image and the reconstructed lidar image.

Further disclosed is a computer readable medium, storing program instructions for executing some or all of the above method steps. Further disclosed is a computer programmed for executing some or all of the above method steps, including a computer apparatus, programmed to render a reconstructed video image based on image three-dimensional (3D) Gaussian splatting by projecting 3D Gaussians from a selected point of view into a frame, render a reconstructed lidar image based on the 3D Gaussian splatting by projecting the 3D Gaussians from the selected point of view into the frame including applying two-dimensional (2D) Gaussian scale compensation to the 3D Gaussians and a depth uncertainty filter to the 3D Gaussians, and supervise training the rendering of the reconstructed video image and the reconstructed lidar image by determining a loss function based combining the reconstructed lidar image with the reconstructed video image. The 3D Gaussians can be determined by modeling lidar image data included in multiple lidar images of a scene. Modeling range data included in the multiple lidar images as 3D Gaussians can include transforming Cartesian coordinates to spherical harmonic coefficients and transforming Gaussian covariance to spherical harmonic coefficients. The 3D Gaussians can be determined by modeling video image data included in multiple video images of a scene. Modeling the video image data included in the multiple video images can include transforming Cartesian coordinates to spherical harmonic coefficients and transforming Gaussian covariance to spherical harmonic coefficients. The frame can be a 2D rectangular shape based on solid angle projection of a field of view of a video camera from the selected point of view.

The instructions can include further instructions wherein 2D Gaussian scale compensation can include re-scaling the 3D Gaussians by increasing covariance Eigenvalues according to distance from the selected point of view. The 3D Gaussians can include a mean in global coordinates, a rotation quaternion, a scaling vector, an opacity, spherical harmonic coefficients which model color surface appearances and a covariance matrix. 3D Gaussian splatting can include determining a location in reconstructed pixel space based on the mean, the rotation quaternion, and scaling vector, and values to be added to the reconstructed pixel space are based on the spherical harmonic coefficients and the covariance matrix. The video images and the lidar images can include moving objects. The moving objects can be detected in lidar images and modeled into moving object 3D Gaussians included in lidar moving object models that include time stamps indicating when the moving object 3D Gaussians included the lidar moving object models were acquired. Rendering the moving object 3D Gaussians into the reconstructed lidar image can include determining trajectories for the moving objects and determining differences in time stamps between the moving object 3D Gaussians and the reconstructed video image. The depth uncertainty filter can remove depth uncertainty caused by projecting one or more of the 3D Gaussians onto a portion of the reconstructed lidar image based on uncertainty estimation. A machine learning model can be trained to operate a vehicle based on the reconstructed video image and the reconstructed lidar image.

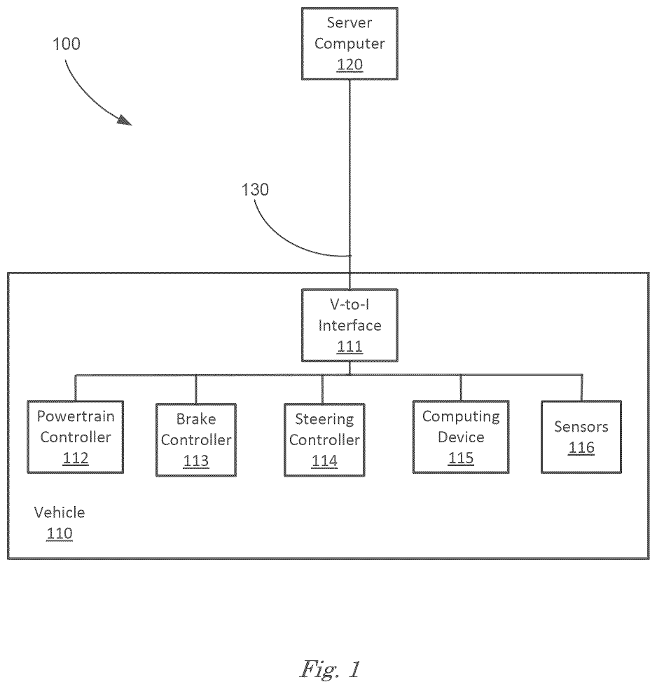

FIG. 1 is a diagram of a vehicle computing system 100. Vehicle computing system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate the vehicle 110 based on data received from the sensors 116 and/or data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle 110 and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2I) interface 111 to a server computer 120.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2I interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2I interface 111 and computing device 115, and therefore these features will not be described further to reduce redundancy. A server computer 120 can be used to develop and train software that can be transmitted to a computing device 115 in a vehicle 110.

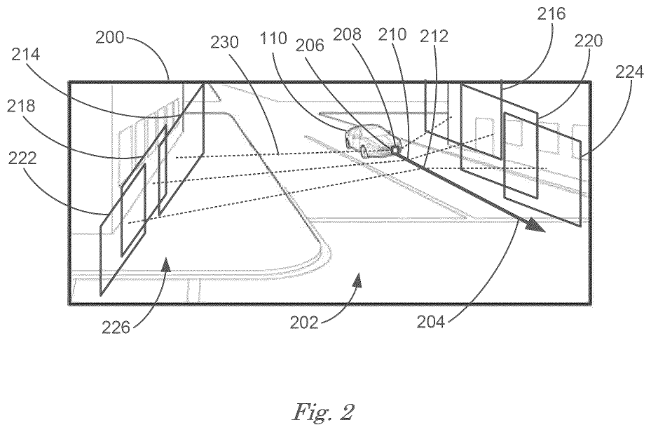

FIG. 2 is a diagram of a scene 200. Scene 200 includes a vehicle 110 traveling on a roadway 202 along a vehicle path 204 in the direction indicated by the arrow representing vehicle path 204. Vehicle 110 includes one or more video cameras 206 that can acquire video images 214, 216, 218, 220, 222, 224, collectively video images 226, as the vehicle 110 travels along vehicle path 204. Optical axes 230 (dotted lines) link the optical center of video cameras 206 with the center of the video images 226. Video images 214, 216 can be acquired by video cameras 206 at a time t₁ when the optical centers of video cameras 206 are located at point 208. Video images 218, 220 can be acquired by video camera 206 at time t₂ when the optical centers of video cameras 206 are located at point 210, and video images 222, 224 can be acquired by video camera 206 are time t₃ when the optical centers of video cameras 206 are located at point 212. Video images 226 can include pixels that indicate the color reflected or emitted by locations in the scene 200. Video cameras 206 included in vehicle 110 can also acquire monochrome images or infrared images in addition to or instead of color video images 226.

Video images 226 can be acquired by video cameras 206 and lidar sensors 306 included in vehicle 110 and can be transmitted by computing device 115 to server computer 120. Server computer 120 can transform the video images 226 to an image model that includes 3D Gaussians. The 3D Gaussians included in the image model can be rendered into reconstructed video images using techniques described herein for lidar supervised scene reconstruction to generate views of scene 200 not included in images 226. Generated images of scene 200 can be included in a training dataset and used to train a machine learning model that can be downloaded to computing device 115 and used to operate a vehicle 110. As discussed above, machine learning model training can benefit by including large numbers of video images in a training dataset. For a given scene 200, a training dataset can be enhanced by techniques described herein which reconstruct video images based on 3D Gaussian splatting. Extended sets of video images can be generated based on points of view included in scene 200 that are based on vehicle paths that differ from vehicle path 204 and include views of scene 200 not included in images 226.

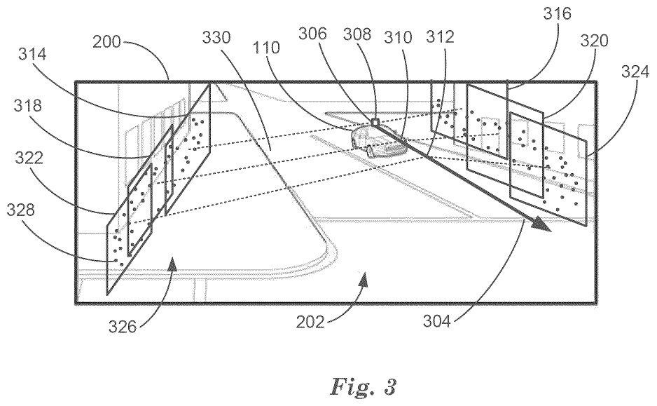

3D Gaussians are determined by modeling video image data included in multiple video images 226 of a scene 200 along with modeling lidar image data included in multiple lidar images 336 as described in relation to FIG. 3, below. Pixel data included in video images 226 can be rendered into reconstructed images that extend the original video images 226 by transforming the video image 226 data into 3D Gaussians. A 3D Gaussians G is composed of a mean μ, a rotation quaternion q, a scaling vector S, an opacity α, spherical harmonic coefficients sh, and lidar visibility rate γ:

G={Gᵢ:(μᵢ,qᵢ,Sᵢ,αᵢ,shᵢ,γᵢ)|i=1, . . . ,N} (1)

Each of the 3D Gaussian's covariance is parameterized by Σ=RSS^{T}R^{T}, where S∈ [symbol] is a scale vector with square roots equal to Σ's eigenvalues and R∈SO(3) is the rotation matrix computed from rotation quaternion q. Σ is a covariance matrix that describes the size and shape of the 3D Gaussian that is applied to the 2D image plane by splatting. Splatting describes the process of adding color data included in spherical harmonic coefficients sh at the location indicated by the 3D Gaussian in the size and shape indicated by the covariance matrix Σ to the pixels of a 2D image frame. Spherical harmonic coefficients model color surface appearances included in the color video images. An image frame is a 2D rectangular shape based on solid angle projection of a field of view of a video camera or lidar sensor. Mean μ is the location of the pixel of the video image or data point of the lidar image coordinates and q is a rotation quaternion measured in global rotational coordinates ρ, φ, and θ measured as rotations about the x, y and z axes, respectively.

Opacity α denotes the ability of the indicated portion of the scene 200 to transmit light and lidar visibility rate γ indicates differences between lidar data acquisition and video image acquisition. For example, lidar signals reflect of surfaces in a scene 200 based on the material and geometry (e.g. the angle of the surface with respect to the lidar sensor). Low reflective or semi-transparent surfaces can be missing in lidar images. Video camera and lidar visibility are differentiated in equation (1) by making

$${α}_{i}^{lidar} = {α}_{i} {γ}_{i} .$$

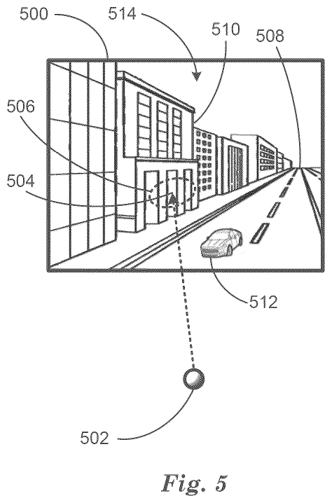

For example, lidar sensors typically only operate at distances under 100-150 meters while video cameras can acquire data at much greater distances. The value of γᵢ is determined during training as discussed below in relation to FIG. 5. The value of γᵢ determined by training can make a surface highly non-transparent and aid in making objects visible in lidar images at long distances.

In addition to opacity α denoting the opaque state in an image, visibility rate γ is introduced to handle the fundamental differences in how video and lidar sensors perceive the environment. For example, lidar reflects off surfaces based on their material and geometry. Low-reflective or semi-transparent surfaces can be missing in lidar images. Moreover, lidar can have a limited sensing range compared to video cameras. For example, a lidar sensor might perceive only 5% of objects at 180 meters, whereas a video camera could capture such more distant objects. To permit video camera and lidar sensor data to be combined with 3D Gaussians, video and lidar visibility are decoupled for each 3D Gaussian via α lidar

$${α}_{i}^{lidar} = {α}_{i} {γ}_{i}$$

to handle open highway scenes with many objects at far distances.

FIG. 3 is a diagram of the scene 200 from FIG. 2. In FIG. 3, scene 200 includes a vehicle 110 traveling on the roadway 202 along the vehicle path 304 in the direction indicated by arrow included in vehicle path 304. Vehicle 110 includes a lidar sensor 306 that can acquire liar images 314, 316, 318, 320, 322, 324, collectively lidar images 326 as the vehicle 110 travels along vehicle path 304. Techniques described herein were designed using a 360-degree rotating lidar sensor installed on the top of vehicle 110. Optical axes 330 (dotted lines) link the optical centers of lidar sensors 306 with the center of the lidar images 326. Lidar images 326 include range data points 328 that indicate distance or range from the range data points 328 to the optical center of the lidar sensor 306. Lidar images 314, 316 can be acquired by lidar sensors 306 at a time t_{1+d} when the optical centers of lidar sensors 306 are located at point 308, lidar images 318, 320 can be acquired by lidar sensor 306 at time t_{2+d} when the optical centers of lidar sensors 306 are located at point 310 and lidar images 322, 324 can be acquired by lidar sensors 306 are time t_{3+d} when the optical centers of lidar sensors 306 are located at point 312.

As described above in relation to FIG. 2, video and lidar data are combined to form 3D Gaussians that include both types of data to permit supervised rendering of the image data. The video image is rendered based on the α value included in the 3D Gaussian and the lidar image is rendered based on the α*γ included in the 3D Gaussian. The 3D Gaussians can be determined by modeling lidar image data included in multiple lidar images 336 of a scene 220 along with video images 226 as described above in relation to FIG. 2. The collection of range data points 328 included in lidar images 326 can be referred to as point cloud data. Point cloud data can be acquired by sensors and/or techniques other than by data from lidar sensors, including stereo cameras, distance-by-motion calculations applied to multiple video images along with real-world location data corresponding to each image, and/or other distance measuring sensors including radar and ultrasound. Lidar images 326 can be transformed into 3D Gaussians along with camera images 226 and processed by a computing device 115 included in vehicle 110 to generate views of scene 200 not included in lidar images 326. Lidar images 326 can also be uploaded to a server computer 120, where they can be transformed along with uploaded video images to 3D Gaussians to generate views of scene 200 not included in video images 326.

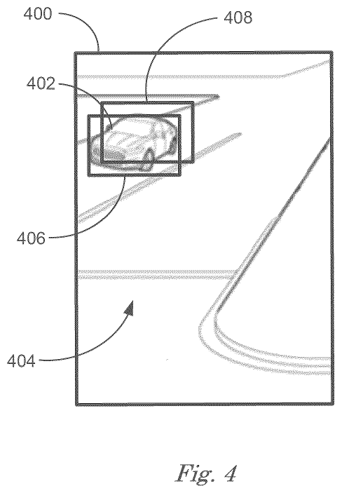

FIG. 4 is a diagram of a video image 400 that includes a moving object, in this example a vehicle 402 on a roadway 404. Bounding box 406 is a minimal enclosing rectangle that includes the vehicle 402. Bounding box 406 can be determined by processing the video image with semantic segmentation software to segment vehicle 402 from the background of determine bounding box 406. An example of semantic segmentation using a deep neural network can be found in Semantic Segmentation Example, http://OpenCV.org as of the filing date of this application. Semantic segmentation can be applied to either video images 226 or lidar images 326. Semantic segmentation can assign labels to portions of video images 226 or lidar images 326. Labels applied to portions of video images 226 or lidar images 326 can include foreground portions or background portions. Foreground portions can include static objects such as buildings, foliage, roadways, ground, etc. or moving objects, also referred to as moving objects, such a vehicles, bicycles, humans, or animals, etc.

Techniques described herein for dynamic lidar supervised scene reconstruction combine reconstructed video images with reconstructed lidar images, both of which can include moving objects corresponding to vehicle 402. Because moving objects such as vehicle 402 are moving objects and because lidar images 326 can be acquired at different times than video images 226, the moving objects included in lidar images 326 can be at different locations than the vehicle 402 as indicated by bounding box 406. For example, a reconstructed lidar image could include a moving object corresponding to vehicle 402 at a location indicated by bounding box 408 (as opposed to the bounding box 406) because of the time difference between the time a video image 226 that includes vehicle 402 was acquired and the time a lidar image 326 that includes a moving object corresponding to vehicle 402 was acquired.

Dynamic lidar supervised scene reconstruction can overcome differences in locations of moving objects in reconstructed video and reconstructed lidar images based on temporal by detecting locations of moving objects in video images using semantic segmentation. Moving objects detected in lidar images can be detected are using semantic segmentation and are removed from the lidar images. Moving objects can alternatively or additionally be identified manually. Following removal from the lidar images, moving objects can be transformed into 3D Gaussians to form lidar moving object models. Following reconstruction of lidar images, the removed lidar moving object models can be rendered and re-inserted at locations that match the locations determined for the moving objects in video images, where object mean μᵢⱼ and covariance Σᵢⱼ are determined according to the following equations:

$${μ}_{ij} = {R}_{j} {μ}_{i j}^{o} + {T}_{j} \qquad ( 2 )$$

$${\sum }_{i j} = {R}_{j} {\sum }_{i j}^{o} {R}_{j}^{T} \qquad ( 3 )$$

### Where

$${μ}_{i j}^{o}$$

are the mean and covariance of the ith 3D Gaussian for the jth object model and Rⱼ and Tⱼ are respectively the object translation and rotation based on determining trajectories for the moving objects and determining the differences in time stamps between the 3D Gaussian moving object models and the reconstructed video image.

FIG. 5 is a diagram of an image 500 determined by dynamic lidar supervised reconstruction based on 3D Gaussians. Image 500 includes objects such as buildings 510 and roadways 508, and a moving object or, in this example a vehicle 512. Video image 500 is generated by 3D Gaussian splatting using 3D Gaussians 502 determined based on video images 226 as described above in relation to FIG. 2. 3D Gaussian splatting refers to adding color values with an opacity to pixels of an image 500 at a location, size, and shape in reconstruction pixel space defined by a 3D Gaussian 502 as defined by equation (1), above. A 3D Gaussian 502 is splatted or added into a 2D image plane 514 at a center 504 μ′ with a covariance 506 Σ′ which define the size and shape of the splat based on the equations:

μ′=KWμ (4)

Σ′=JWΣW^{T}J^{T} (5)

Where W is the camera pose with respect to the world frame, K is the camera intrinsic matrix, and J is the Jacobian of K used to project the 3D covariance Σ into the 2D image plane. Camera pose includes both the location of the camera optical center in x, y, and z global coordinates and the rotational coordinates ρ, φ, and θ of the optical axis.

The pixel color Ĉ(p) is determined as:

$$\hat{C} ( p ) = {\sum }_{i ∈ N} {c}_{i} {α}_{i}^{′} {\prod }_{j = 1}^{i - 1} ( 1 - {α}_{j}^{′} ) \qquad ( 6 )$$

Where p is the pixel in the image 500 and cᵢ is the color of the 3D Gaussian 502 obtained from shᵢ and view direction υ. The opacity,

$${α}_{i}^{′} ,$$

of the 3D Gaussian 502 at pixel x′ is given by the equation:

$${α}_{i}^{′} = {α}_{i} exp ( - \frac{1}{2} {( {x}^{′} - {u}_{i}^{′} )}^{T} {\sum }_{i}^{- 1} ( {x}^{′} - {u}_{i}^{′} ) ) \qquad ( 7 )$$

Where x′ is the rendered pixel x′ and the 3D Gaussian 502 center 504

$${u}_{i}^{′}$$

is projected onto the 2D image plane 514. Techniques for dynamic lidar supervised reconstruction can render images 500 by splatting 3D Gaussians 502 from 1 . . . . N onto a 2D image plane 514 with the frame of image 500 as described by equations (4-7). 3D Gaussian splatting includes determining a location in reconstructed pixel space based on the mean, the rotation quaternion, and scaling vector, and the values to be added to the reconstructed pixel space are based on the spherical harmonic coefficients and the covariance matrix.

Reconstruction of images 500 based on 3D Gaussians 502 can be enhanced by supervised training of 3D Gaussian splatting. Reconstruction of images 500 can be enhanced by determining 3D Gaussians 502 based on a video image 226, reconstructing the image 500 from the same point of view from which the original video image 226 was acquired and then comparing the original video image 226 to the reconstructed image 500. Pixel-wise subtraction between the original video image 226 and the reconstructed image 500 can be performed to determine a loss function that measures the accuracy of the reconstructed image 500. Parameters that guide the selection of 3D Gaussians 502 that correspond to the original video image 226 can be adjusted to enhance 3D Gaussian splatting by making the reconstructed image 500 more closely match the original video image 226.

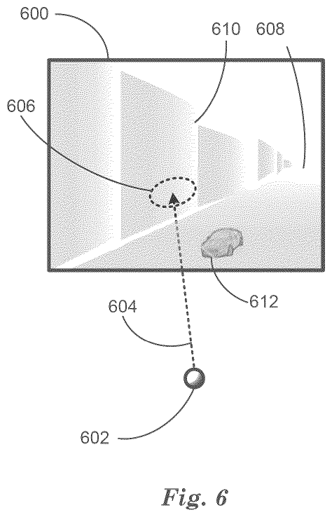

In addition, reconstructed lidar image 600 as described below in relation to FIG. 6 can be used to supervise training of 3D Gaussian splatting by rendering the reconstructed lidar image 600 into the same frame from the same point of view as the reconstructed video image 500. Rendering the reconstructed lidar image 600 and the reconstructed video image 500 permits the determination of a loss function based on reconstructed lidar image 600 to further enhance 3D Gaussian splatting. Data from reconstructed lidar image 600 can be projected onto the reconstructed image 500 to determine weights for loss functions depending upon the value of reconstructed lidar image 600 data for portions of the reconstructed image 500. A loss function [symbol] that incorporates reconstructed lidar image 600 data projected onto the reconstructed image 500 is given by:

$$ℒ = {ℒ}_{c} + {λ}_{1} {ℒ}_{Lidar} + {λ}_{2} {ℒ}_{opa}^{L} + {λ}_{3} {ℒ}_{reg}^{s} + {λ}_{4} {ℒ}_{opa}^{c} \qquad ( 8 )$$

$${ℒ}_{opa}^{c} = {ℒ}_{sky} + {ℒ}_{fg} + {ℒ}_{reg}^{obj}$$

Color loss [symbol] _{c} is the sum of differences between color values in the reconstructed image 500 and the original video image 226. Lidar loss is calculated as the L1 or Euclidian difference between range data points 328 of the original lidar image 326 and rendered range data points according to the equation:

[symbol]

_{Lidar}=∥ [symbol] _{ing}− [symbol] ∥₁ (10)

Where [symbol] _{ing} is the range data point 328 from the original lidar image and [symbol] is the rendered range data point

$${ℒ}_{opa}^{L}$$

sets lidar visibility α_{lidar}=1 for pixels with non-zero depth returns in the rendered range image.

$${ℒ}_{r e g}^{s}$$

is a scale regularization term that makes the 3D Gaussians more evenly shaped to prevent spike artifacts and provide more accurate depth rendering

$${ℒ}_{opa}^{c}$$

includes opacity losses from the reconstructed image 500 by including [symbol] _{sky} which sets pixels included in sky portions of the reconstructed image 500 to have low opacity and [symbol] _{fg} sets foreground pixels of the reconstructed image 500 to have high opacity. Additionally,

$${ℒ}_{r e g}^{o b j}$$

is a regularization term that can reduce the effect of noise pixels and enhance decomposition of foreground objects from the image background.

Parameters λ₁, λ₂, λ₃, and λ₄ are constants with values between 0 and 1.0 that can be determined empirically to weight the loss values based on determining values of [symbol] for multiple original video images 226 and original lidar images 336 with corresponding reconstructed video images 500 and reconstructed lidar images 600, respectively. For example, the constants λ₁, λ₂, λ₃, and λ₄ can be determined to account for differences in ranges of values between the loss functions of equation (8) so that one or more loss functions do not dominate the determination of overall loss function [symbol] . Because the loss function is differentiable, partial derivatives of the loss function with respect to the Gaussian parameters μᵢ, qᵢ, Sᵢ, αᵢ, shᵢ, γᵢ can indicate in which direction and magnitude the parameters should be adjusted to reduce the loss function [symbol] to a minimum. Reducing the loss function to a minimum enhances the accuracy of the reconstructed video images 500 and reconstructed lidar images 600.

FIG. 6 is a diagram of a lidar image 600 determined by dynamic lidar supervised reconstruction based on 3D Gaussians 602. Image 600 includes objects such as buildings 610 and roadways 608, and a moving object, in this example a vehicle 612. As described above 3D Gaussians 602 used to generate vehicle 612 in lidar image 600 are separate from the 3D Gaussians 602 used to generate the rest of lidar image 600. As described above in relation to FIG. 4, this permits the reconstructed lidar data points that indicate the vehicle 612 in lidar image 600 to be located and oriented to match the location and orientation of a corresponding vehicle 512 occurring in reconstructed image 500.

3D Gaussians 602 are determined by modeling range data included in the multiple lidar images 336 of a scene 200. To render a reconstructed lidar image 600 from 3D Gaussians 602, the 3D Gaussian means u are transformed from the original Cartesian coordinates to spherical coordinates by the following equations:

r=\sqrt{x²+y²+z²} (11)

$$θ = arc tan 2 ( y , x ) \qquad ( 12 )$$

$$ϕ = arc tan 2 ( \frac{z}{r} ) \qquad ( 13 )$$

The 3D Gaussians 602 are projected into the lidar image 600 frame. For a lidar with N beams and an inclination ¢={φ₁, φ₂, . . . , φ_{N}}, a coordinate in the lidar image 600 [symbol] ∈ [symbol] is represented as (v, u) where vis the index of the closest element in Φ and

$$u = \frac{θ W}{2 π} .$$

A lidar beam is approximated as a frustrum of a range image pixel for beams with a low angle resolution. While most lidar sensors have a sparse beam distribution on the edge of the field of view, 3D Gaussians 602 can be filtered out when the center of the beam diverges from the beam angle. This occurs when the center of the closest beam is too far off from the beam angle (e.g. |φ_{Closest}−φ|<0.5°).

The same technique is used to project the 3D covariance matrix Σ by first transforming the 3D covariance matrix Σ to spherical space by the equation:

Σ_{spherical}=JΣJ^{T} (14)

Where the Jacobian J is determined by the equation:

$$J = [ \begin{matrix}\frac{\partial r}{\partial x} & \frac{\partial r}{\partial y} & \frac{\partial r}{\partial z} \\ \frac{\partial θ}{\partial x} & \frac{\partial θ}{\partial y} & \frac{\partial θ}{\partial z} \\ \frac{\partial ϕ}{\partial x} & \frac{\partial ϕ}{\partial y} & \frac{\partial ϕ}{\partial z}\end{matrix} ] = [ \begin{matrix}\frac{x}{r} & \frac{y}{r} & \frac{z}{r} \\ \frac{- y}{{x}^{2} + {y}^{2}} & \frac{x}{{x}^{2} + {y}^{2}} & 0 \\ \frac{- xz}{{r}^{2} \sqrt{{r}^{2} - {z}^{2}}} & \frac{- yz}{{r}^{2} \sqrt{{r}^{2} - {z}^{2}}} & \frac{{r}^{2} \sqrt{{r}^{2} - {z}^{2}}}{{r}^{2}} ]\end{matrix} ] \qquad ( 15 )$$

The transformed 3D Gaussian is then projected 604 into the lidar image 600 range space by the equation:

Σᵤᵥ=AΣ_{spherical}A^{T} (16)

Where the Jacobian projection matrix A is a function of the elevation angle resolution:

$${A}_{i} = [ \begin{matrix}\frac{1}{{Δθ}_{i}} & 0 \\ 0 & \frac{W}{2 π}\end{matrix} ] \qquad ( 17 )$$

### Where

$${Δθ}_{i} = \frac{1}{2} ( {θ}_{v + 1} - {θ}_{v - 1} ) .$$

The projected 604 3D Gaussians 602 can be sorted by the distance of their center r from the selected point of view and the rendered range data [symbol] can be rasterized by intersecting the ellipse 606 formed by the 3D covariance with a projection of the x, y address of the pixel to correctly determine the pixel range data.

Scene reconstruction based on projecting 3D Gaussians can be challenging for rendering Gaussians at long distances (e.g., distances greater than about 50 meters). At long distances, projected Gaussians become invisible in the projected pixel plane due to numerical instability. Because techniques described herein combine image and lidar data in 3D Gaussians 602, a 3D Gaussian can be modified to remain fully visible when the center of the 3D Gaussian is determined to be adjacent to a projected lidar ray. 3D Gaussians that occur near a lidar ray and are scaled below a visible threshold can be rescaled to make them appear visible in the projected image by applying 2D Gaussian scale compensation. 2D Gaussian scale compensation includes re-scaling the lidar 3D Gaussians by increasing covariance Eigenvalues according to distance from a selected point of view as described below in equations (18)-(21).

Eigen decomposition can be applied to a projected 3D Gaussian 2 to determine its 2D scale following projection by the equations:

$${Σ}_{u v}^{i} = {V}_{i} {S}_{u v}^{i} {V}_{i}^{- 1} , S = diag ( {s}_{1} , {s}_{2} ) \qquad ( 18 )$$

Where V is a visibility matrix that transforms scale values in S into Gaussian covariance values and S is a diagonal matrix that determines the x and y scales in pixels. Visibility scale \tilde{s}δ can depend on the distance the 3D Gaussian is to be projected into the image space by the equation:

$${\tilde{s}}_{δ} = 2 {d}_{i} tan ( \frac{π}{ω} ) \qquad ( 19 )$$

Where dᵢ is the distance of the lidar data point and π/ω is the size of the ray that connects the optical center of the lidar sensor to the lidar data point. 3D Gaussians that include a scale sᵢⱼ that is too small compared to the visibility scale

$${s}_{δ}^{i}$$

for the ith 3D Gaussian can be adjusted according to the equation:

$${\tilde{s}}_{i , j} = \{ \begin{matrix}\frac{{s}_{δ}^{i}}{3} , & if {s}_{ij} < \frac{{s}_{δ}^{i}}{3} \\ {s}_{ij} , & otherwise\end{matrix} \qquad ( 20 )$$

The adjusted ith 2D covariance matrix

$${\tilde{Σ}}_{u v}^{i}$$

can be determined by the equation:

$${\tilde{Σ}}_{u v}^{i} = {V}_{i} diag ( {\tilde{s}}_{i 1} , {\tilde{s}}_{i 2} ) {V}_{i}^{- 1} \qquad ( 21 )$$

Applying 2D Gaussian scale compensation as described above in equations (18)-(21) can make 3D Gaussian covariance values visible in reconstructed images 500 despite their occurrence at long distances from the optical centers of the cameras that acquired the data. 2D Gaussian scale compensation permits reconstruction of scenes that include long distance data, for example highway scenes.

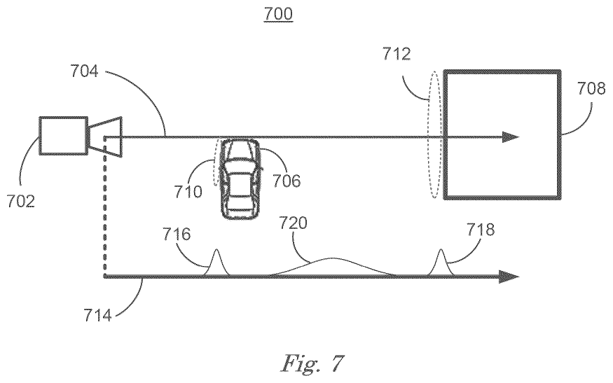

FIG. 7 is a diagram of a scene 700 illustrating depth uncertainty filtering applied to a 3D Gaussian. A lidar sensor 702 can acquire range data along a ray 704. Ray 704 can have a finite width due to the solid angle included in the laser beam that forms the ray 704. In the example illustrated in FIG. 7, ray 704 can encounter a vehicle 706 and a building 708, and receive reflected return radiation from both the vehicle 706 and the building 708. Lidar data points acquired along ray 704 corresponding to the vehicle 706 can be used to form a 3D Gaussian 710 that indicates the lidar distance to the vehicle 706 and a 3D Gaussian 712 that indicates the lidar distance to the building 708. Graph 714 indicates a distribution 716 of range data indicated by 3D Gaussian 710 and a distribution 718 of range data indicated by 3D Gaussian 712. Forming a single 3D Gaussian indicated by ray 704 can result in a distribution 720 that averages the distributions 716, 718 indicated by vehicle 706 and building 708. A 3D Gaussian that includes distribution 720 can generate a Gaussian at a distance from lidar sensor 702 along ray 704 between 3D Gaussian 710 and 3D Gaussian 712 that does not correspond to any object included in scene 700. A 3D Gaussian that does not correspond to any object in a scene 700 can be labeled a floating noise data point.

Because video cameras do not provide direct depth measurements, techniques described herein project lidar point cloud data into the image plane to generate depth images for 3D Gaussian splatting training. The rendered depth for each pixel \hat{D}(p) is computed by the equation:

$$\hat{D} ( p ) = {\sum }_{i ∈ N} {d}_{i} {α}_{i}^{′} {\prod }_{j = 1}^{i - 1} ( 1 - {α}_{j}^{′} ) \qquad ( 22 )$$

Where dᵢ is the depth of the 3D Gaussian center. Noise data points can be reduced or eliminated in lidar images rendered from 3D Gaussians by identifying pixels that cause floating noise in a rendered image. A low-pass filter using an uncertainty threshold can be applied to the rendered image to filter out floating noise data points. Uncertainty estimation can be included in the rendering process by calculating an incremental weighted variance I′n along each ray 704 according to the equations:

$${W}_{n} = {W}_{n - 1} + {α}_{n}^{′} \qquad ( 23 )$$

$${μ}_{n} = {μ}_{n - 1} + \frac{{α}_{n}^{′}}{{W}_{n}} ( {d}_{n} - {μ}_{n - 1} ) \qquad ( 24 )$$

$${Γ}_{n} = {Γ}_{n - 1} + {α}_{n}^{′} \cdot \frac{{W}_{n - 1}}{{W}_{n}} ( {d}_{n} - {μ}_{n - 1} ) {( {d}_{n} - {μ}_{n - 1} )}^{T} \qquad ( 25 )$$

Where Wn is the accumulated opacity along a ray, with the initial value of W₀=0, and

$${α}_{n}^{′}$$

is the opacity of the 3D Gaussian being rendered. Γₙ is the determined depth variance. When the weighted variance Γₙ is greater than the threshold the current data point can be eliminated.

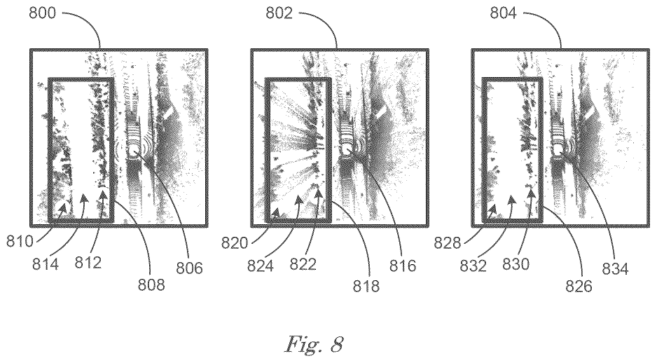

FIG. 8 is a diagram illustrating uncertainty estimation applied to rendering lidar data from 3D Gaussians. A bird's eye view (BEV) lidar image 800 includes a lidar sensor 806 and a region of interest (ROI) 808 that includes objects 810, 812. In this example lidar sensor 806 can be included in a vehicle 110 and objects 810, 812 can be foliage or ground on either side of a roadway 814. Note that roadway 814 is clear of objects and does not include any lidar return data.

BEV reconstructed lidar image 802 is rendered by forming 3D Gaussians from the lidar range data points in lidar image 800 and projecting the 3D Gaussians from the location of the lidar sensor 816. ROI 818 includes rendered returns from the objects 820, 822 and floating noise 824 caused by averaging data from the 3D Gaussians corresponding to objects 820, 822 as described above in relation to FIG. 7.

BEV reconstructed lidar image 804 is rendered by projecting the 3D Gaussians from the location of lidar sensor 834 based on uncertainty estimation as described above in equations (22)-(24). The threshold can be empirically determined to eliminate range data points in the roadway portion 832 while retaining range data points in regions that include objects 828, 830 included in ROI 826 that correspond to real objects 810, 812.

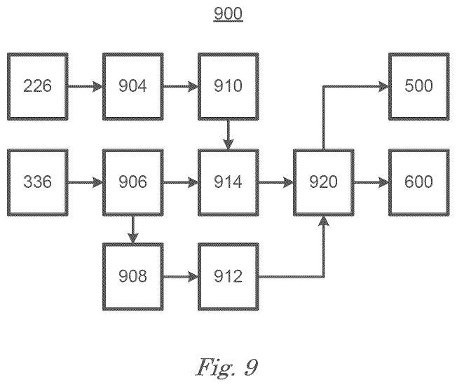

FIG. 9 is a diagram of a dynamic lidar supervised scene reconstruction system 900, including process blocks 904-912 and images 226, 336, 500, 600. Lidar supervised scene reconstruction system 900 receives as input video images 226 of a scene 200 as described in relation to FIG. 2, above, and lidar images 336 of a scene 200 as described above in relation to FIG. 3, above. Video images 226 are received by semantic segmentation process block 904 which segments the video images 226 to determine foreground objects and background portions of the video images 226. Lidar images 336 are received by semantic segmentation process block 906 which determines objects included in the lidar images 336, removes the objects from the lidar images 336 and outputs them as moving object point clouds 908. Video images 226 and segmented images are passed to SfM process block 910 where an SfM image is constructed as described above. The SfM image is passed to video/lidar Gaussian process block 914 where the SfM image is combined with the lidar images 336 prior to forming lidar 3D Gaussians from the combined SfM and lidar images 336 for training as discussed above in relation to FIG. 3.

The video images 226, semantic segmented images, and lidar images 336 with moving objects removed are passed to video/lidar Gaussian process block 914 which also transforms the video images 226 and lidar images 336 into combined video/lidar 3D Gaussians as described above in relation to FIG. 2. The combined video/lidar 3D Gaussians and are passed to video/lidar reconstruction process block 920 where the video/lidar 3D Gaussians are reconstructed to form video images 500 as described in relation to FIG. 5 and lidar images 600 as described in relation to FIG. 6. The moving objects point clouds are rendered into lidar moving objects by lidar moving object reconstruction process block 912 and inserted into the lidar images at video/lidar reconstruction process block 920 at locations determined based on the time the lidar images were acquired as described in relation to FIG. 4, above.

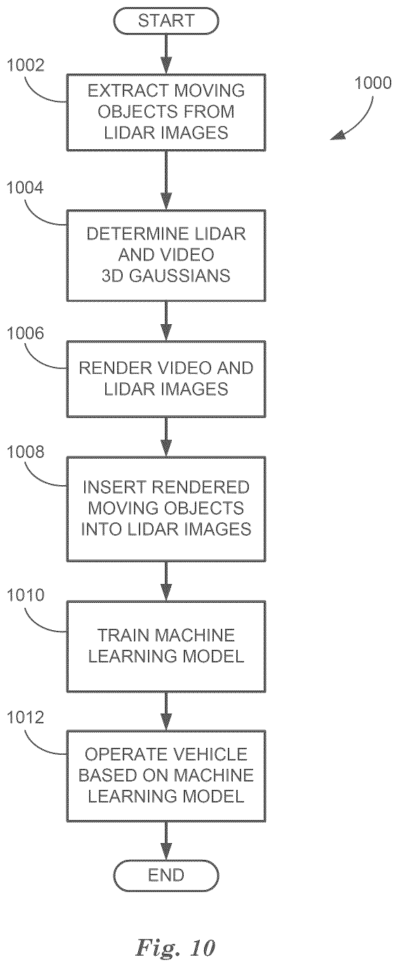

FIG. 10 is a flowchart of a process 1000 for training a neural network based on dynamic lidar supervised scene reconstruction. Process 1000 can be implemented on a server computer 120 and downloaded to a computing device 115 included in a vehicle 110, for example. Process 1000 includes multiple blocks that can be executed in the illustrated order. Process 1000 could alternatively or additionally include fewer blocks or can include the blocks executed in different orders.

Process 1000 begins at block 1002, where a server computer 120 segments a lidar image 336 of a scene 200 are to remove moving objects as described above in relation to FIG. 3 and transforms the extracted moving objects into 3D Gaussians. Video images can be processed to form SfM sparse point cloud data for training the rendering process by initializing the 3D Gaussians. The SfM data can be used as ground truth data to change generated 3D Gaussians shape and color to match the ground truth in the training step.

At block 1004 the server computer 120 determines combined video/lidar 3D Gaussians from video images 226 and lidar images 336 as described above in relation to FIGS. 2 and 3, above.

At block 1006 the server computer 120 renders the combined video/lidar 3D Gaussians into reconstructed video images 500 and lidar images 600 using Gaussian splatting. Rendering the video images 500 and lidar images 600 from combined video/lidar 3D Gaussians using Gaussian splatting permits supervised rendering of the video image 500 based on lidar data included in the video/lidar 3D Gaussians as described above in relation to FIGS. 5 and 6.

At block 1008 the server computer 120 combines rendered moving objects with the reconstructed lidar images 600 to generate dynamic reconstructed lidar images 500 described in relation to FIG. 4, above.

At block 1010 the server computer 120 combines the reconstructed lidar images 600 and the reconstructed video images 500 with ground truth data determined based on the segmented locations of moving objects determined at block 1006, above, to train a machine learning model which can be a neural network. Following training, the machine learning model can be downloaded by server computer 120 to a computing device 115 in a vehicle 110.

At block 1012 the computing device 115 included in vehicle 110 operates the vehicle 110 by inputting data from sensors 116 including video cameras and lidar sensors. The sensor data is received by the downloaded machine learning model, which outputs predictions regarding identities and locations of objects included in an environment around the vehicle 110. Computing device 115 can determine a vehicle path based on the identities and locations of objects around the vehicle 110 and operate the vehicle 110 on the vehicle path by controlling vehicle components as described above in relation to FIG. 1. Following block 1012 process 1000 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system comprising:
a computer including a processor and a memory storing instructions executable by the processor to:
render a reconstructed video image based on three-dimensional (3D) Gaussian splatting by projecting 3D Gaussians from a selected point of view into a frame;
render a reconstructed lidar image based on the 3D Gaussian splatting by projecting the 3D Gaussians from the selected point of view into the frame including applying two-dimensional (2D) Gaussian scale compensation to the 3D Gaussians and a depth uncertainty filter to the 3D Gaussians; and
supervise training the rendering of the reconstructed video image and the reconstructed lidar image by determining a loss function based combining the reconstructed lidar image with the reconstructed video image.

2. The system of claim 1, wherein the 3D Gaussians are determined by modeling lidar image data included in multiple lidar images of a scene.

3. The system of claim 2, wherein modeling range data included in the multiple lidar images as 3D Gaussians includes transforming Cartesian coordinates to spherical harmonic coefficients and transforming Gaussian covariance to spherical harmonic coefficients.

4. The system of claim 1, wherein the 3D Gaussians are determined by modeling video image data included in multiple video images of a scene.

5. The system of claim 4, wherein modeling the video image data included in the multiple video images includes transforming Cartesian coordinates to spherical harmonic coefficients and transforming Gaussian covariance to spherical harmonic coefficients.

6. The system of claim 1, wherein the frame is a 2D rectangular shape based on solid angle projection of a field of view of a video camera from the selected point of view.

7. The system of claim 1, wherein 2D Gaussian scale compensation includes re-scaling the 3D Gaussians by increasing covariance Eigenvalues according to distance from the selected point of view.

8. The system of claim 1, wherein the 3D Gaussians include a mean in global coordinates, a rotation quaternion, a scaling vector, an opacity, spherical harmonic coefficients which model color surface appearances and a covariance matrix.

9. The system of claim 8, wherein 3D Gaussian splatting includes determining a location in reconstructed pixel space based on the mean, the rotation quaternion, and scaling vector, and values to be added to the reconstructed pixel space are based on the spherical harmonic coefficients and the covariance matrix.

10. The system of claim 1, wherein the video images and the lidar images include moving objects.

11. The system of claim 10, wherein the moving objects are detected in lidar images and modeled into moving object 3D Gaussians included in moving object models that include time stamps indicating when the moving object 3D Gaussians included in the lidar moving object models were acquired.

12. The system of claim 11, wherein rendering the moving object 3D Gaussians into the reconstructed lidar image includes determining trajectories for the moving objects and determining differences in time stamps between the moving object 3D Gaussians and the reconstructed video image.

13. The system of claim 1, wherein the depth uncertainty filter removes depth uncertainty caused by projecting one or more of the 3D Gaussians onto a portion of the reconstructed lidar image based on uncertainty estimation.

14. The system of claim 1, wherein a machine learning model is trained to operate a vehicle based on the reconstructed video image and the reconstructed lidar image.

15. The system of claim 14, wherein the trained machine learning model is downloaded to a second computer included in the vehicle to operate the vehicle.

16. A method comprising:
rendering a reconstructed video image based on image three-dimensional (3D) Gaussian splatting by projecting 3D Gaussians from a selected point of view into a frame;
rendering a reconstructed lidar image based on the 3D Gaussian splatting by projecting the 3D Gaussians from the selected point of view into the frame including applying two-dimensional (2D) Gaussian scale compensation to the 3D Gaussians and a depth uncertainty filter to the 3D Gaussians; and
supervising training the rendering of the reconstructed video image and the reconstructed lidar image by determining a loss function based combining the reconstructed lidar image with the reconstructed video image.

17. The method of claim 16, wherein the 3D Gaussians are determined by modeling range data included in multiple lidar images of a scene.

18. The method of claim 17, wherein modeling the range data included in the multiple lidar images as 3D Gaussians includes transforming Cartesian coordinates to spherical harmonic coefficients and transforming Gaussian covariance to spherical harmonic coefficients.

19. The method of claim 16, wherein the 3D Gaussians are determined by modeling video image data included in multiple video images of a scene.

20. The method of claim 19, wherein modeling the video image data included in the multiple video images includes transforming Cartesian coordinates to spherical harmonic coefficients and transforming Gaussian covariance to spherical harmonic coefficients.
